(19) United States
(12) Patent Application Publication
(10) Pub. No.: US 2013/0132336 A1
(43) Pub. Date: May 23, 2013

(54) COMMUNICATION APPARATUS THAT IMPROVES USABILITY OF ADDRESS BOOKS, CONTROL METHOD THEREFOR, AND STORAGE MEDIUM

(71) Applicant: CANON KABUSHIKI KAISHA, Tokyo (JP)

(72) Inventor: Kiwamu Suzuki, Kawasaki-shi (JP)

(73) Assignee: CANON KABUSHIKI KAISHA, Tokyo (JP)

(21) Appl. No.: 13/668,547

(22) Filed: Nov. 5, 2012

(30) Foreign Application Priority Data
Nov. 21, 2011 (JP) 2011-253904

(51) Int. Cl. G06F 17/30

(52) U.S. Cl. 707/609; 707/E17.005

(57) ABSTRACT

A communication apparatus which is capable of improving usability of address books provided for respective ones of a plurality of users. When a destination included in the address books has been updated by any user among the plurality of users, a process result indicating that the destination has been updated, and descriptions of a process determined according to the process result are stored in association with and in conjunction with the destination in a storage device. The process corresponding to the destination is carried out on address books of users different from the user who has updated the destination, the address books including the destination stored in the storage device.

### BACKGROUND OF THE INVENTION

1. Field of the Invention

The present invention relates to a communication apparatus, a control method therefor, and a computer-readable storage medium storing a control program for implementing the method.

2. Description of the Related Art

Image forming apparatuses typified by copiers and multifunctional peripherals are used to read an original by an original reading unit, carry out image processing on read image data, and print or transmit the image data that has been subjected to image processing.

In general, when a transmission process is to be carried out using such an image forming apparatus, an original is placed on an original reading unit, a destination to which an image is to be transmitted is input, and image data is transmitted to the destination.

Examples of methods to input a destination to which an image is to be transmitted in such a transmission process include a method in which a user directly inputs a destination and a method in which a destination is obtained from an address book.

The method in which a destination is obtained from an address book is used so as to simplify inputting of a destination by registering a destination in an image forming apparatus or a server in advance, and when using a destination, recalling the registered destination.

As for techniques relating to the transmission process and the method to input a destination, there has been known a technique relating to the transmission process according to which the number of failures in transmission to a destination is counted, and a destination to which transmission has repeatedly ended in failure a predetermined number of times is nullified (see, for example, Japanese Laid-Open Patent Publication (Kokai) No. 2002-281092).

Moreover, examples of techniques relating to the method to input a destination include a technique described hereafter. When a destination that has been directly input is a destination that was registered in an address book in the past but is not registered in the address book at the time of input, a process to cancel transmission to the destination is carried out if the destination has been deleted (see, for example, Japanese Laid-Open Patent Publication (Kokai) No. 2009-105803).

In this technical background, there is an image forming apparatus that enables a plurality of users to register the same destination. Specifically, address books are provided for respective users, and for example, when the same destination is registered in the address books of a user A and a user B, the same destination is registered in the plurality of the address books as a result.

At this time, the user A among the plurality of users updates a certain destination X. In this case, when the same destination X is included in the address book of the user B, the destination X in the address book of the user B as well is likely to be subjected to update.

Further, during communication, when an error occurred when the user A transmitted data to a certain destination, the same error is likely to occur when the user B transmits data to the same destination later.

Namely, what happens in relation to a certain destination is likely to happen when the same destination as that destination is used next time.

However, the technique disclosed in Japanese Laid-Open Patent Publication (Kokai) No. 2002-281092 is focused on only one particular piece of destination information registered in an address book, and hence when an error occurs during transmission using this piece of destination information, only this piece of destination information is nullified.

For this reason, when there are a plurality of same destinations in address books, a problem that even if a destination for the user A is nullified, a destination for the user B cannot be nullified will arise according to the technique intended for a plurality of destinations.

There may be a case where, for the same destination registered in the plurality of the address books, a certain user changes this destination in his/her address book, and in this case, the same destination as the changed destination in the other address books is likely to be changed.

However, the above described technique disclosed in Japanese Laid-Open Patent Publication (Kokai) No. 2009-105803 is focused on only one particular piece of destination information registered in address books, and according to this technique, a destination that was registered in address books in the past but is not registered at the time of input is targeted to be subjected to an appropriate process.

For this reason, there is a problem that when the same destination is registered in the plurality of the address books, a user cannot be notified of an appropriate process.

Namely, the techniques disclosed in Japanese Laid-Open Patent Publication (Kokai) No. 2002-281092 and Japanese Laid-Open Patent Publication (Kokai) No. 2009-105803 are based on the assumption that a plurality of data pieces having the same destination is not registered in address books in an image forming apparatus, and no consideration is given to an image forming apparatus in that the same destination is registered in the plurality of the address books.

Therefore, although these techniques aim at assisting a user by notifying the user of an appropriate process, they present a problem that a user cannot be notified of an appropriate process, depending on the way of using address books in an image forming apparatus.

### SUMMARY OF THE INVENTION

The present invention provides a communication apparatus and a control method therefor that are capable of improving usability of address books provided for respective ones of a plurality of users, as well as a computer-readable storage medium storing a control program for implementing the method.

Accordingly, a first aspect of the present invention provides a communication apparatus with a storage device, in which address books including at least one destination to which data is to be transmitted are provided for respective ones of users, and which is capable of transmitting data to the at least one destination, comprising a storage unit configured to, when a destination included in the address books has been updated by any user among the plurality of users, store in the storage device a process result indicating that the destination has been updated, and descriptions of a process determined according to the process result in association with and in conjunction with the destination, and an execution unit configured to carry out a process concerning the descriptions of the process corresponding to the destination on address books of users different from the user who has updated the destination, the address books including the destination stored in the storage device by the storage unit.

Accordingly, a second aspect of the present invention provides a communication apparatus with a storage device, in which address books including at least one destination to which data is to be transmitted are provided for respective ones of users, and which is capable of transmitting data to the at least one destination, comprising a storage unit configured to store, in the storage device, a process result indicating that transmission of data to the destination included in the address books carried out by any user among the plurality of users has ended in failure, and descriptions of a process determined according to the process result in association with and in conjunction with the destination, and an execution unit configured to carry out a process concerning the descriptions of the process corresponding to the destination on address books of users different from the user who has failed in transmitting data, the address books including the destination stored in the storage device by the storage unit.

Accordingly, a third aspect of the present invention provides a control method for a communication apparatus with a storage device, in which address books including at least one destination to which data is to be transmitted are provided for respective ones of users, and which is capable of transmitting data to the at least one destination, comprising a storage step of, when a destination included in the address books has been updated by any user among the plurality of users, storing in the storage device a process result indicating that the destination has been updated, and descriptions of a process determined according to the process result in association with and in conjunction with the destination, and an execution step of carrying out a process concerning the descriptions of the process corresponding to the destination on address books of users different from the user who has updated the destination, the address books including the destination stored in the storage device in the storage step.

Accordingly, a fourth aspect of the present invention provides a control method for a communication apparatus with a storage device, in which address books including at least one destination to which data is to be transmitted are provided for respective ones of users, and which is capable of transmitting data to the at least one destination, comprising a storage step of storing, in the storage device, a process result indicating that transmission of data to the destination included in the address books carried out by any user among the plurality of users has ended in failure, and descriptions of a process determined according to the process result in association with and in conjunction with the destination, and an execution step of carrying out a process concerning the descriptions of the process corresponding to the destination on address books of users different from the user who has failed in transmitting data, the address books including the destination stored in the storage device in the storage step.

Accordingly, a fifth aspect of the present invention provides A non-transitory computer-readable storage medium storing a program for causing a computer to implement a control method for a communication apparatus with a storage device, in which address books including at least one destination to which data is to be transmitted are provided for respective ones of users, and which is capable of transmitting data to the at least one destination, the control method comprising a storage step of, when a destination included in the address books has been updated by any user among the plurality of users, storing in the storage device a process result indicating that the destination has been updated, and descriptions of a process determined according to the process result in association with and in conjunction with the destination, and an execution step of carrying out a process concerning the descriptions of the process corresponding to the destination on address books of users different from the user who has updated the destination, the address books including the destination stored in the storage device in the storage step.

Accordingly, a sixth aspect of the present invention provides a non-transitory computer-readable storage medium storing a program for causing a computer to implement a control method for a communication apparatus with a storage device, in which address books including at least one destination to which data is to be transmitted are provided for respective ones of users, and which is capable of transmitting data to the at least one destination, the control method comprising a storage step of storing, in the storage device, a process result indicating that transmission of data to the destination included in the address books carried out by any user among the plurality of users has ended in failure, and descriptions of a process determined according to the process result in association with and in conjunction with the destination, and an execution step of carrying out a process concerning the descriptions of the process corresponding to the destination on address books of users different from the user who has failed in transmitting data, the address books including the destination stored in the storage device in the storage step.

According to the present invention, usability of address books provided for respective ones of a plurality of users can be improved.

Further features of the present invention will become apparent from the following description of exemplary embodiments (with reference to the attached drawings).

### BRIEF DESCRIPTION OF THE DRAWINGS

FIG. 1 is a diagram schematically showing a hardware arrangement of an image forming apparatus according to an embodiment of the present invention.

FIG. 2 is a diagram schematically showing a software arrangement of the image forming apparatus according to the embodiment of the present invention.

FIG. 3 is a view showing a destination event table stored in an external memory appearing in FIG. 1.

FIG. 4 is a flowchart showing the procedure of a data transmission process carried out by a CPU appearing in FIG. 1.

FIG. 5 is a flowchart showing the procedure of a destination event process in step S404 in FIG. 4.

FIG. 6 is a view showing an exemplary message displayed on an operation unit appearing in FIG. 1.

FIG. 7 is a flowchart showing the procedure of a destination event registration process in step S409 in FIG. 4.

FIG. 8 is a flowchart showing the procedure of an address book updating process carried out by the CPU appearing in FIG. 1.

FIG. 9 is a view showing an exemplary message displayed on the operation unit appearing in FIG. 1.

FIG. 10 is a flowchart showing the procedure of an address book deleting process carried out by the CPU appearing in FIG. 1.

FIG. 11 is a view showing an exemplary message displayed on the operation unit appearing in FIG. 1.

### DESCRIPTION OF THE EMBODIMENTS

The present invention will now be described in detail with reference to the drawings showing an embodiment thereof. It should be noted that in the present embodiment described hereafter, a communication apparatus according to the present invention is applied to an image forming apparatus.

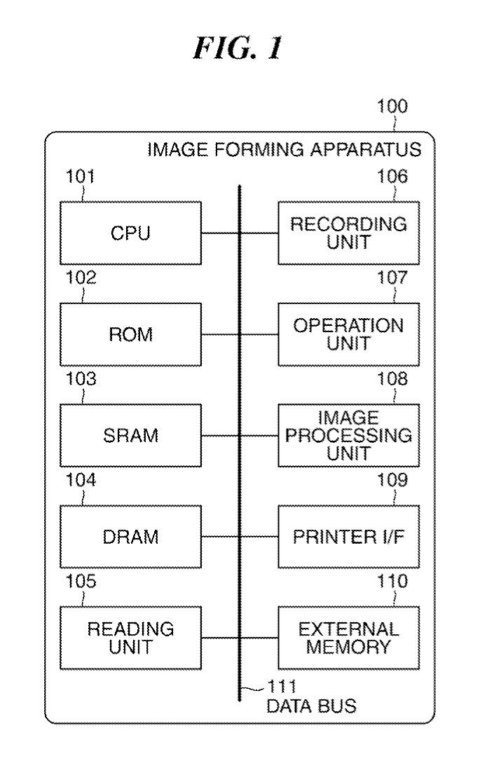

FIG. 1 is a diagram schematically showing a hardware arrangement of an image forming apparatus 100 according to the embodiment of the present invention.

Referring to FIG. 1, a CPU 101 controls the overall operation of the image forming apparatus 100. Various programs to be executed by the CPU 101 are stored in a ROM 102. An SRAM 103 can be battery-protected. Setting values registered by an operator, management data on the image forming apparatus 100, registration data on users, various work data, and so on are stored in the SRAM 103. Program control variables and others are stored in a DRAM 104.

A reading unit 105 reads an original and converts it into image data (binary data), and hence an original can be read with a copying function. A recording unit 106 outputs image data to a recording sheet.

An operation unit 107 (display unit) is an interface with a user, which displays information on the image forming apparatus 100 for a user and receives information input by the user. An image processing unit 108 carries out, for example, encoding-decoding processing on image data handled in copying and transmission processing.

A printer I/F 109, which is an interface with an external apparatus, transmits image data to an external apparatus and accesses an external server using a network, a USB, and so on. An external memory 110 (storage device), which is comprised of a storage medium such as flash memory, a hard disk, or the like and connected to various components via a data bus 110, is a storage unit that stores setting values registered by users, device management data, registration data on users, and so on.

The image forming apparatus 100 according to the present embodiment can temporarily store image data, which is obtained by placing an original on the reading unit 105 and reading the original, in the DRAM 104 and transmit the image data to an external apparatus by the printer I/F 109.

At this time, a user can operate the operation unit 107 to change settings for a destination. Methods to set a destination include a method in which a destination is set by directly inputting it, and a method in which an address book is recalled, and a destination is set from the address book. In the present embodiment, address books including destinations to which data is to be transmitted are provided for respective ones of a plurality of users.

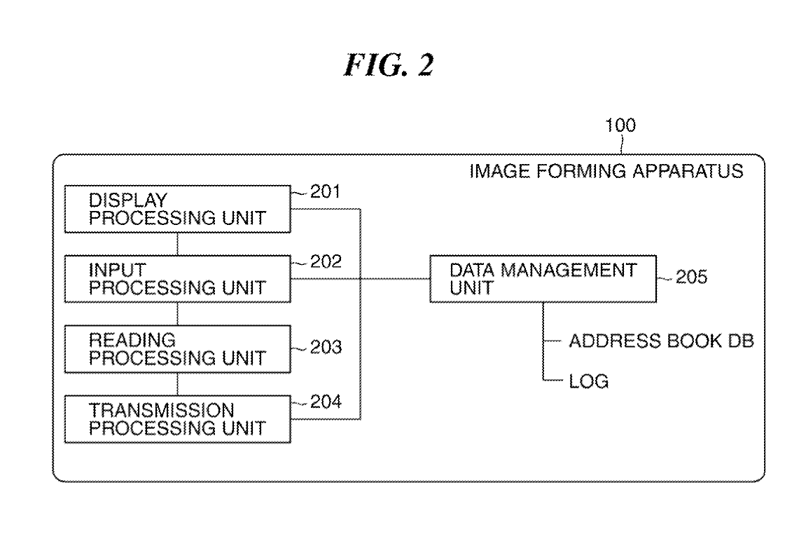

FIG. 2 is a diagram schematically showing a software arrangement of the image forming apparatus 100 according to the embodiment of the present invention.

The image forming apparatus 100 is comprised of a display processing unit 201, an input processing unit 202, a reading processing unit 203, a transmission processing unit 204, and a data management unit 205.

The display processing unit 201 notifies messages and produces screen displays. The input processing unit 202 configures destination settings and transmission settings. The reading processing unit 203 reads an original. The transmission processing unit 204 transmits image data obtained by reading. The data management unit 205 performs data management such as management of address books and management of logs.

Thus, the image forming apparatus 100 according to the present embodiment is capable of transmitting data to a destination.

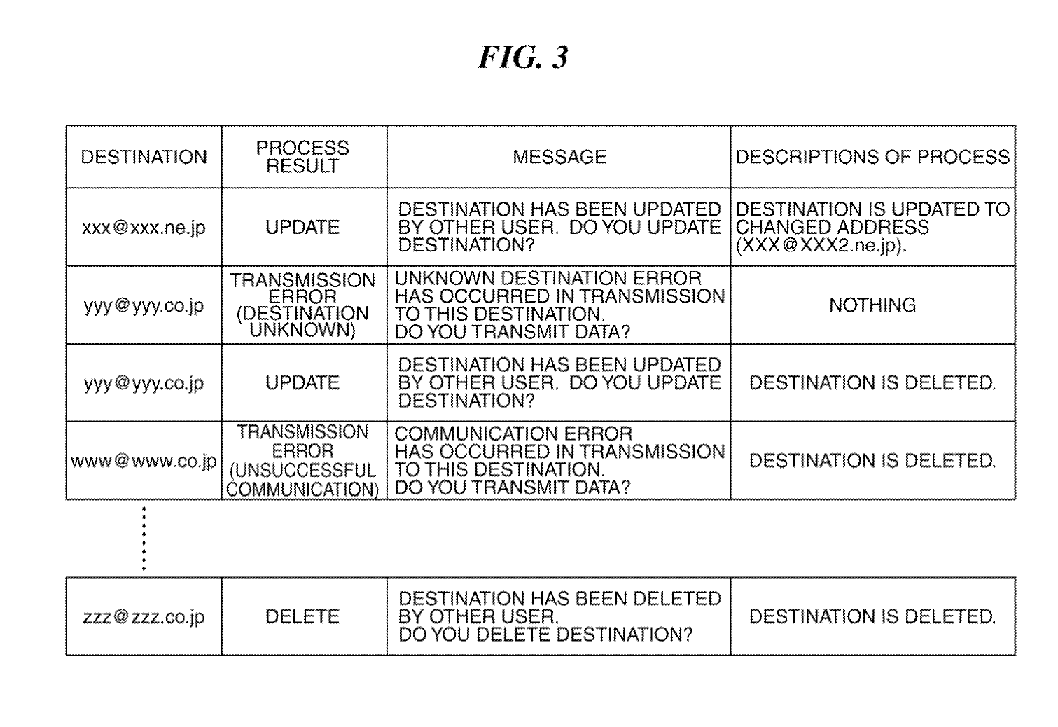

FIG. 3 is a view showing a destination event table stored in the external memory 110 appearing in FIG. 1.

Referring to FIG. 3, the destination event table is comprised of destinations, process results, messages, and process descriptions.

Mail addresses are shown as exemplary destinations, but any other things may be used as long as they can identify destinations. Updates and transmission errors are shown as exemplary process results, but any other things may be used. Messages are associated with the process results, and in the case of updating, a message saying, for example, that a destination has been updated is shown. Occurrence of a communication error is shown as an exemplary transmission error. Process descriptions are descriptions of processes that are determined according to process results and carried out so as to cope with the process results. When there is any process to cope with a process result, details thereof are described, and when there is no process to cope with a process result, “Nothing” is written.

It should be noted that what is registered in the destination event table can be manually deleted by a user.

Thus, when a destination included in address books has been updated by any user among a plurality of users, the image forming apparatus 100 stores, in the external memory 110, a process result indicating that the destination has been updated. Further, the image forming apparatus 100 store descriptions of a process, which is determined according to the process result, in association with the updated destination and in conjunction with the destination in the external memory 110.

Also, the image forming apparatus 100 stores, in the external memory 110, a process result indicating that data transmission by any user among a plurality of users to a destination included in address books has ended in failure. Similarly to the case of updating, the image forming apparatus 100 store a description of a process, which is determined according to the process result, in association with the updated destination and in conjunction with the destination in the external memory 110.

As shown in FIG. 3, descriptions of a process are descriptions of a process that updates a destination in address books of users different from a user who has updated, or a process that deletes this destination. Also, descriptions of a process are descriptions of a process that deletes a destination in address books of users different from a user who has failed in transmitting data.

Further, as shown in FIG. 3, messages corresponding to process results as well as destinations, process results, and process descriptions are also stored in the external memory 110.

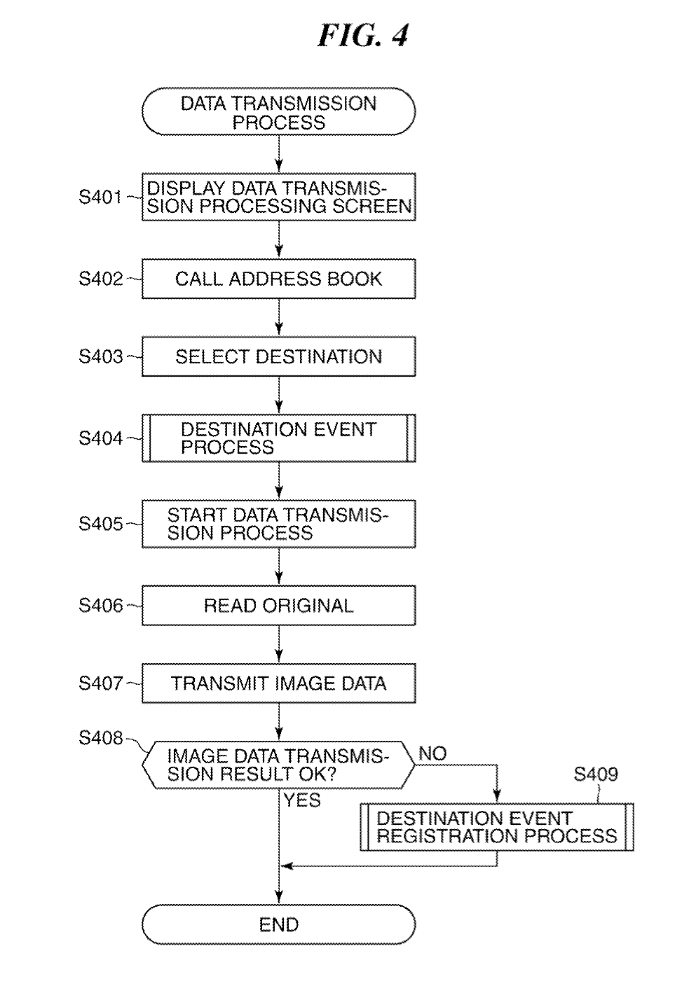

FIG. 4 is a flowchart showing the procedure of a data transmission process carried out by the CPU 101 appearing in FIG. 1.

It should be noted that a program for carrying out the data transmission process is stored in the ROM 102, and this program is loaded into the DRAM 104 and executed by the CPU 101.

Referring to FIG. 4, to transmit image data, the display processing unit 201 displays a data transmission process screen using the operation unit 107 (step S401). Based on information input from the screen displayed by the display processing unit 201, the data management unit 205 recalls address books using the data bus 111 and the external memory 110 (step S402).

The input processing unit 202 selects a destination selected from the address books by a user (step S403). Based on the input destination, the input processing unit 202 carries out a destination event process in which it carries out message notification or an appropriate process (step S404) and starts a data transmission process (step S405).

By using the reading unit 105 and the image processing unit 108, the reading processing unit 203 reads an original to be transmitted (step S406). By using the printer I/F 109, the transmission processing unit 204 transmits image data (step S407).

The transmission processing unit 204 determines whether or not the image data has been successfully transmitted without occurrence of an error, that is, a transmission process result is OK (step S408).

When as a result of the determination in the step S408, the transmission process result is OK (YES in the step S408), the present process is terminated. On the other hand, when the transmission process result is not OK due to occurrence of an error (NO in the step S408), a destination event registration process for recording a phenomenon that has occurred for this destination is carried out (step S409), followed by termination of the present process.

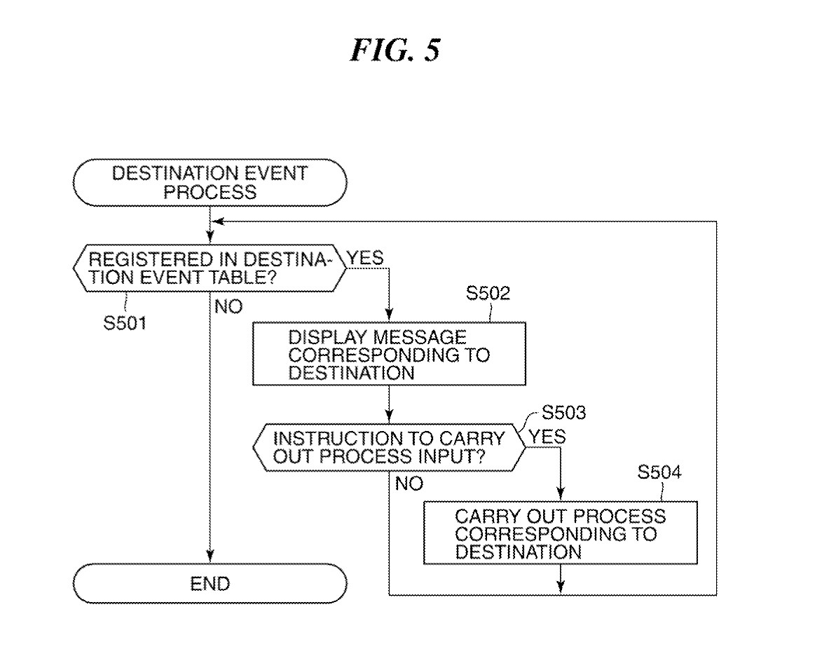

FIG. 5 is a flowchart showing the procedure of the destination event process in the ste S504 in FIG. 4.

Referring to FIG. 5, the data management unit 205 accesses the destination event table using the data bus 111 and the external memory 110, and determines whether or not the input destination is registered in the destination event table (step S501).

When as a result of the determination in the step S501, the input destination is not registered in the destination event table (NO in the step S501), the present process is terminated. On the other hand, when the input destination is registered in the destination event table (YES in the step S501), the data management unit 205 displays a message corresponding to the destination from the destination event table (step S502).

Then, the user is prompted to input as to whether or not to carry out a process corresponding to the message, and it is determined whether or not the user has input an instruction to carry out the process (step S503). When as a result of the determination in the step S503, the instruction to carry out the process has not been input (NO in the step S503), the process proceeds to the step S501. On the other hand, when the instruction to carry out the process has been input (YES in the step S503), the process corresponding to the destination is carried out (step S504), and the process returns to the step S501. As in the step S504, when the user has input an instruction to carry out the process, the process is carried out.

According to the processes shown in FIGS. 4 and 5, when a destination included in address books is updated by any user among a plurality of users, the image forming apparatus 100 carries out a process described hereafter. First, a process result indicating that a destination has been updated and descriptions of a process determined according to the process result are stored in association with and in conjunction with the updated destination in the external memory 110. Then, the process corresponding to the destination is carried out on address books of users different from the user who has done the update. Thus, an update or the like by any other user is reflected on one's own address book, and hence usability of address books provided for respective ones of a plurality of users can be improved.

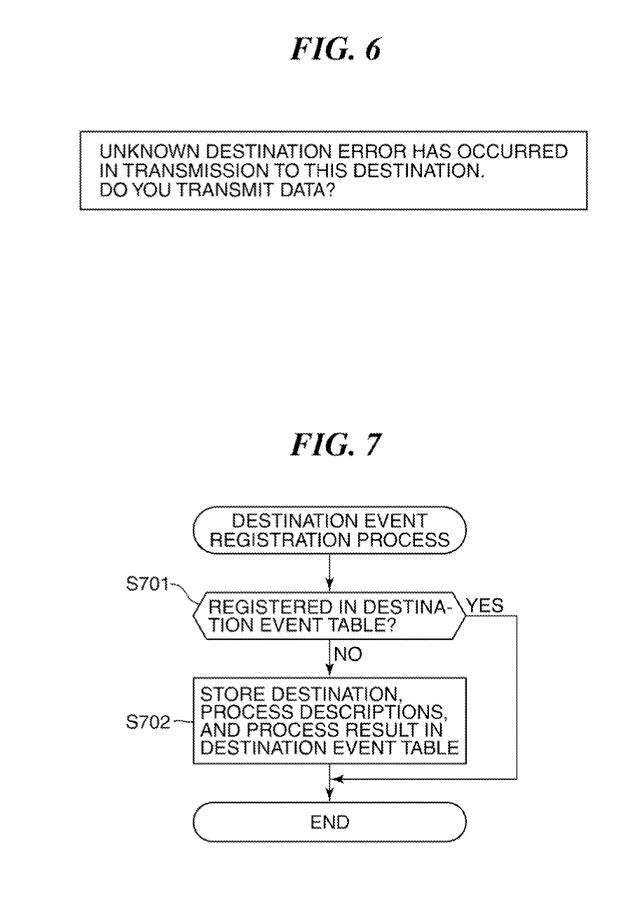

FIG. 6 is a view showing an exemplary message displayed on the operation unit 107 appearing in FIG. 1.

The message shown in FIG. 6 is a message displayed in a case where a process whose transmission process result is a destination transmission error due to a destination unknown is registered as an event. Other messages as well are displayed in the same way.

FIG. 7 is a flowchart showing the procedure of the destination event registration process in the step S409 in FIG. 4.

Referring to FIG. 7, the data management unit 205 accesses the destination event table using the data bus 111 and the external memory 110, and determines whether or not the input destination has already been registered in the destination event table (step S701).

When as a result of the determination in the step S701, the input destination has already been registered in the destination event table (YES in the step S701), the present process is terminated. On the other hand, when the input destination has not yet been registered in the destination event table (NO in the step S701), the data management unit 205 registers the destination, process result, message, and descriptions of the process in the destination event table (step S502), followed by terminating the present process.

In the first embodiment, access to address books is made in a series of processes for transmitting image data. In a second embodiment described hereafter, image data is not transmitted, but only address books are used, and data in the address books is updated. It should be noted that an arrangement of the image forming apparatus 100 is the same as that of the image forming apparatus 100 according to the first embodiment shown in FIGS. 1 and 2, and therefore, description thereof is omitted.

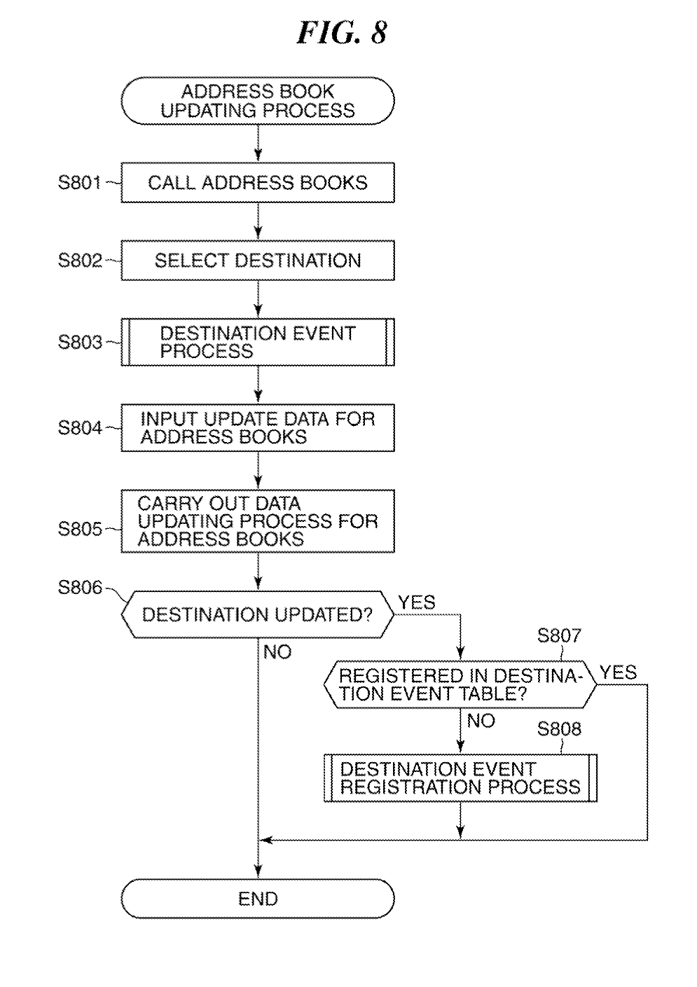

FIG. 8 is a flowchart showing the procedure of an address book updating process carried out by the CPU 101 appearing in FIG. 1.

Referring to FIG. 8, based on information input from a screen displayed by the display processing unit 201, the data management unit 205 recalls address books using the data bus 111 and the external memory 110 (step S801).

Next, the input processing unit 202 selects a destination input by a user from the address books (step S802). Then, the input processing unit 202 carries out the destination event process shown in FIG. 5 (step S803).

Then, the input processing unit 202 inputs update data for the address book updated by the user (step S804). Then, the data management unit 205 carries out a data updating process for the address book (step S805).

It is then determined whether or not the destination has been updated in the data updating process (step S806). When as a result of the determination in the step S806, the destination has not been updated (NO in the step S806), the present process is terminated.

On the other hand, when as a result of the determination in the step S806, the destination has been updated (YES in the step S806), it is determined whether or not the destination is registered in the destination event table (step S807). It should be noted that in the step S807, even in a case where the destination is present in the destination event table, it is determined that the destination is not registered when a registered process is different.

When as a result of the determination in the step S807, the destination is registered in the destination event table (YES in the step S807), the present process is terminated. On the other hand, when the destination is not registered in the destination event table (NO in the step S807), the destination event registration process shown in FIG. 7 is carried out (step S808), followed by termination of the present process.

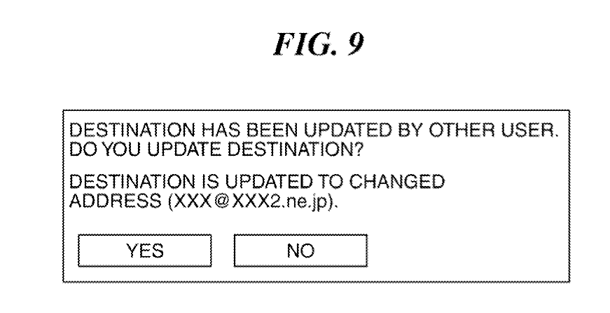

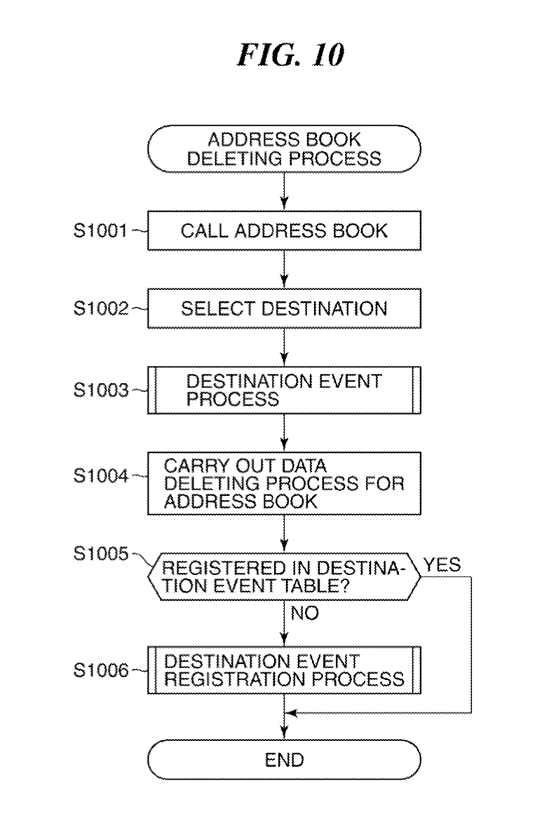

FIG. 9 is a view showing an exemplary message displayed on the operation unit 107 appearing in FIG. 1.

The message shown in FIG. 9 is an exemplary message displayed in a case where in the address book updating process in FIG. 8, matters registered in the destination event registration process (step S808) are displayed in the destination event process in FIG. 5.

In the first embodiment, access to address books is made in a series of processes for transmitting image data. In a third embodiment described hereafter, however, image data is not transmitted, but only address books are used, and data in the address book is deleted.

FIG. 10 is a flowchart showing the procedure of an address book deleting process carried out by the CPU 101 appearing in FIG. 1.

Referring to FIG. 10, based on information input from a screen displayed by the display processing unit 201, the data management unit 205 recalls address books using the data bus 111 and the external memory 110 (step S1001).

Next, the input processing unit 202 selects a destination input by a user from the address books (step S1002). Then, the input processing unit 202 carries out the destination event process in FIG. 5 (step S1003).

Then, the data management unit 205 carries out a data deleting process for the address books (step S1004).

It is then determined whether or not the destination to be deleted is registered in the destination event table (step S1005). In the step S1005, even in a case where the destination is present in the destination event table, it is determined that the destination is not registered when a registered process is different.

When as a result of the determination in the step S1005, the destination to be deleted is registered in the destination event table (YES in the step S1005), the present process is terminated. On the other hand, when the destination to be deleted is not registered in the destination event table (NO in the step S1005), the destination event registration process shown in FIG. 7 is carried out (step S1006), followed by termination of the present process.

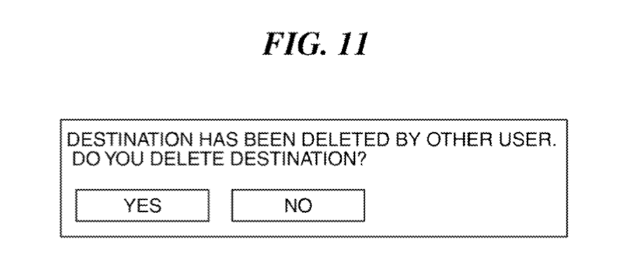

FIG. 11 is a view showing an exemplary message displayed on the operation unit 107 appearing in FIG. 1.

The message shown in FIG. 11 is an exemplary message displayed in a case where matters registered in the destination event registration process (step S1006) in the address book deleting process in FIG. 10 are displayed in the destination event process in FIG. 5.

Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-253904 filed Nov. 21, 2011, which is hereby incorporated by reference herein in its entirety.

What is claimed is:

1. A communication apparatus with a storage device, in which address books including at least one destination to which data is to be transmitted are provided for respective ones of users, and which is capable of transmitting data to the at least one destination, comprising:
a storage unit configured to, when a destination included in the address books has been updated by any user among the plurality of users, store in the storage device a process result indicating that the destination has been updated, and descriptions of a process determined according to the process result in association with and in conjunction with the destination; and
an execution unit configured to carry out a process concerning the descriptions of the process corresponding to the destination on address books of users different from the user who has updated the destination, the address books including the destination stored in the storage device by said storage unit.

2. A communication apparatus according to claim 1, wherein the descriptions of the process is a process to update the destination in the address books of the users different from the user who has updated the destination, or a process to delete the destination.

3. A communication apparatus according to claim 1, wherein said storage unit stores in the storage device a process result indicating that transmission of data to the destination included in the address books carried out by any user among the plurality of users has ended in failure, and the descriptions of the process determined according to the process result in association with and in conjunction with the updated destination, and
said execution unit carries out a process concerning the descriptions of the process corresponding to the destination on address books of users different from the user who has failed in transmitting data, the address books including the destination stored in the storage device by said storage unit.

4. A communication apparatus according to claim 3, wherein the descriptions of the process is a process to delete the destination in the address books of the users different from the user who has failed in transmitting data.

5. A communication apparatus according to claim 1, further comprising a display unit configured to display information for the user,
wherein in the storage device, a message corresponding to the process result is stored in addition to the destination, the process result, and the descriptions of the process by said storage unit,
the message is displayed on said display unit, and
when an instruction to carry out the process concerning the descriptions of the process is input by the user, said execution unit carries out the process.

6. A communication apparatus with a storage device, in which address books including at least one destination to which data is to be transmitted are provided for respective ones of users, and which is capable of transmitting data to the at least one destination, comprising:
a storage unit configured to store, in the storage device, a process result indicating that transmission of data to the destination included in the address books carried out by any user among the plurality of users has ended in failure, and descriptions of a process determined according to the process result in association with and in conjunction with the destination; and
an execution unit configured to carry out a process concerning the descriptions of the process corresponding to the destination on address books of users different from the user who has failed in transmitting data, the address books including the destination stored in the storage device by said storage unit.

7. A control method for a communication apparatus with a storage device, in which address books including at least one destination to which data is to be transmitted are provided for respective ones of users, and which is capable of transmitting data to the at least one destination, comprising:
a storage step of, when a destination included in the address books has been updated by any user among the plurality of users, storing in the storage device a process result indicating that the destination has been updated, and descriptions of a process determined according to the process result in association with and in conjunction with the destination; and
an execution step of carrying out a process concerning the descriptions of the process corresponding to the destination on address books of users different from the user who has updated the destination, the address books including the destination stored in the storage device in said storage step.

8. A control method for a communication apparatus with a storage device, in which address books including at least one destination to which data is to be transmitted are provided for respective ones of users, and which is capable of transmitting data to the at least one destination, comprising:
a storage step of storing, in the storage device, a process result indicating that transmission of data to the destination included in the address books carried out by any user among the plurality of users has ended in failure, and descriptions of a process determined according to the process result in association with and in conjunction with the destination; and
an execution step of carrying out a process concerning the descriptions of the process corresponding to the destination on address books of users different from the user who has failed in transmitting data, the address books including the destination stored in the storage device in said storage step.

9. A non-transitory computer-readable storage medium storing a program for causing a computer to implement a control method for a communication apparatus with a storage device, in which address books including at least one destination to which data is to be transmitted are provided for respective ones of users, and which is capable of transmitting data to the at least one destination, the control method comprising:
a storage step of, when a destination included in the address books has been updated by any user among the plurality of users, storing in the storage device a process result indicating that the destination has been updated, and descriptions of a process determined according to the process result in association with and in conjunction with the destination; and
an execution step of carrying out a process concerning the descriptions of the process corresponding to the destination on address books of users different from the user who has updated the destination, the address books including the destination stored in the storage device in said storage step.

10. A non-transitory computer-readable storage medium storing a program for causing a computer to implement a control method for a communication apparatus with a storage device, in which address books including at least one destination to which data is to be transmitted are provided for respective ones of users, and which is capable of transmitting data to the at least one destination, the control method comprising:
a storage step of storing, in the storage device, a process result indicating that transmission of data to the destination included in the address books carried out by any user among the plurality of users has ended in failure, and descriptions of a process determined according to the process result in association with and in conjunction with the destination; and
an execution step of carrying out a process concerning the descriptions of the process corresponding to the destination on address books of users different from the user who has failed in transmitting data, the address books including the destination stored in the storage device in said storage step.
